(19) United States
(12) Patent Application Publication
(10) Pub. No.: US 2007/0277163 A1
(43) Pub. Date: Nov. 29, 2007

(54) Method and tool for automatic verification of software protocols

(75) Inventor: Dimiter R. Avresky, Brighton, MA (US)

Correspondence Address: LAHIVE & COCKFIELD, LLP, ONE POST OFFICE SQUARE, BOSTON, MA, 02109-2127, US

(73) Assignee: Syver, LLC, Brighton, MA (US)

(21) Appl. No.: 11/807,310

(22) Filed: May 24, 2007

Related U.S. Application Data
(60) Provisional application No. 60/802,965, filed on May 24, 2006.

(51) Int. Cl. G06F 9/45

(52) U.S. Cl. 717/140; 717/146; 717/144

(57) ABSTRACT

Disclosed herein, a method of automatically verifying software code is provided. The method may include generating a logic representation of the software code, identifying a set of well-defined formula sequences in the logic representation of the software code, and verifying the software code based on the set of well-defined formula sequences. Exemplary embodiments of the verification method verify completeness and consistency of the software code and ensure complete code coverage.

### REFERENCE TO RELATED APPLICATIONS

This application claims priority to Provisional Application Ser. No. 60/802,965, filed May 24, 2006, and incorporated herein by reference.

### BACKGROUND

Software verification is a discipline in software engineering employed to assure that software fully satisfies its expected requirements. The continued rise in the use of complex software products in real-world and experimental systems has increased the use of automatic means of software verification in verifying software under development or developed software.

Research by DeMarco and Lister shows that professional programmers average 1.2 software faults for every 200 lines of code written. At this rate, a typical software project of 200,000 lines of can easily contain over 1,000 programming errors. Moreover, as programs grow larger, the rate of software defects increases geometrically. These defects buried deep within code can elude programmers, convention debuggers, and even the most sophisticated test suites until after the product has been released. Finding software defects is not only extremely difficult but also very expensive. In fact, a Microsoft study shows that it takes an average of 12 programming hours to find and fix a software defect. At this rate, it can take over 12,000 hours (or 5.7 man-years) to debug a program of 200,000 lines of code, at a cost of over $500,000 (http://www.parasoft.com/jsp/pr/runtimes.jsp?runtimeId=584). A 2002 study reported that software bugs cost the U.S. economy $59.6 billion each year, and that one third of the bugs could be eliminated by an improved testing infrastructure (RTI International, “Software Bugs Cost U.S. Economy $59.6 Billion Annually, RTI Study Finds,” Jul. 1, 2002, and Information Technology Project Management, Fourth Edition, Chapter 8: Project Quality Management, ISBN-10: 619215267, Mar. 15, 2005).

As an example, the Intel® Pentium 4 processor consists of around 1.5 million lines of Register Transfer Language (RTL) code. Intel® quoted an industry average of approximately 1 bug for every 200 lines of code. Intel® discovered 8,000 bugs (1 bug/187 lines) in the code in the pre-silicon phase and discovered another 100 bugs in the post-silicon phase. Four hundred of the bugs were discovered via model checking, twenty of which would have never been found via simulation (Intel's Errata Data, May 97 to April 98). Many organizations are spending as much as 33 to 50% of the total cost of ownership of their computing and communication systems to avoid software failure. Oftentimes, code verification engineers outnumber design engineers by 3 to 1 (National Institute of Standard and Technology, 2004).

Current software verification techniques offer only a partial solution. They provide non-exhaustive coverage of the software and semantic faults are usually not detected. Uncertainty in current verification techniques due to the above issues necessitates extra verification steps and can lead to mission failures. Costs of mission failures may be enormous for mission-critical software and for customer value reasons.

C remains a popular programming language for the development of software programs and protocols. One approach of verifying code written in the C programming language is based on abstract interpretation, a formal theory of discrete approximation applied to the semantic models of computer systems. Abstract interpretation is a theory of approximation of mathematical structures, particularly those involved in the semantic models of computer systems. It is focused on abstract numerical domains that specialize in the automatic discovery of properties of the numerical variables in software programs. An abstract interpretation-based static analyzer automatically signals all possible runtime errors by examining the numerical properties of all program variables, and may occasionally signal non-existent errors, i.e. false alarms.

Abstract interpretation verification aims to verify that the C programming language is correctly used in a software program and ensures the absence of runtime errors during execution in any environment. However, this approach of software verification does not provide backward analysis of the inputs of the software program. Examples of run-time errors that may be detected by abstract interpretation include:
1) Any use of C defined by the international norm governing the C programming language as having an undefined behavior (such as division by zero or out of bounds array indexing);
2) Any use of C violating the implementation-specific behavior on a given machine (such as the size of integers and arithmetic overflow);
3) Any potentially harmful or incorrect use of C violating optional user-defined programming guidelines (such as no modular arithmetic for integers even though this might be the hardware choice); and
4) Any violation of optional, user-provided input assertions (similar to assertion diagnostics for example) to prove user-defined run-time properties;

Another conventional approach for verifying C programs is based on an idea similar to abstract interpretation that applies control structure analysis to calculate the domain of values each variable can take at each point in the application. It provides automatic detection of runtime errors at compilation time, e.g. read access to non-initialized data, de-referencing through null and out-of-bounds pointers, out-of-bounds array access, invalid arithmetic operations (such as division by zero, square roots of negative numbers), dangerous type conversions (long to short, float to int), access conflicts for data shared between threads, non-terminating function calls and loops, unreachable or dead code. Other approaches exist for the verification of software written in programming languages other than C. Software verification tools for Linux and Unix commonly detect memory corruption and leaks.

### SUMMARY

The present implementation discloses methods and tools for automatic verification of software programs and protocols. Exemplary embodiments receive a portion of software code of a software program or protocol, convert it into an intermediate representation and use the intermediate representation to automatically verify the software code.

In one embodiment, a computer-implemented method of verifying software code is provided. The method may include generating a first intermediate representation of the software code and generating a second intermediate representation of the software code from the first intermediate representation. The method may further include deriving a set of well-defined formula sequences from the second intermediate representation of the software code and verifying the software code based on the set of well-defined formula sequences.

In another embodiment, a system in a computer for verifying software code is provided. The system may include a first intermediate representation generation facility that generates a first intermediate representation of the software code and a second intermediate representation generation facility that generates a second intermediate representation of the software code from the first intermediate representation. The system may further include a well-defined formula sequence generation facility that generates a set of well-defined formula sequences in the second intermediate representation of the software code. The system may also include a code verification facility that verifies the software code based on the set of well-defined formula sequences.

In another embodiment, a computer-readable medium storing executable instructions for causing a computing device to verify software code is provided. The instructions may include instructions for generating a first intermediate representation of the software code and a second intermediate representation of the software code based on the first intermediate representation. The instructions may further include instructions for generating a set of well-defined formula sequences in the second intermediate representation of the software code and verifying the software code based on the set of well-defined formula sequences.

### BRIEF DESCRIPTION OF THE DRAWINGS

The accompanying drawings, which are incorporated in and constitute a part of this specification, illustrate one or more embodiments of the implementation and, together with the description, explain the implementation. In the drawings,

FIG. 1 illustrates an exemplary computing device suitable for practicing exemplary embodiments;

FIG. 2 illustrates a flowchart depicting steps performed by exemplary embodiments to verify software code;

FIG. 3A illustrates an exemplary abstract syntax tree;

FIG. 3B illustrates an exemplary reduced abstract syntax tree;

FIG. 4 illustrates an exemplary behavior model function;

FIG. 5 illustrates an exemplary well-defined formula;

FIG. 6 illustrates an exemplary well-defined formula sequence;

FIG. 7 illustrates a flowchart depicting steps performed by exemplary embodiments to derive a complete set of well-defined formula sequences;

FIG. 8 illustrates a flowchart depicting steps performed by exemplary embodiments to report faults in the source code to the user;

FIG. 9 illustrates a flowchart summarizing steps performed by exemplary embodiments to verify source code and correct faults in the source code;

FIG. 10 illustrates an exemplary distributed system suitable for a distributed implementation of exemplary embodiments.

### DETAILED DESCRIPTION

Exemplary embodiments are directed to implementing an automatic software verification tool. Exemplary embodiments employ a novel technology to establish a sign-off paradigm for fault-free software programs and protocols which solve the software verification bottleneck issues discussed above, while reducing the cost of verification. Exemplary embodiments present a formal verification solution for delivering up to 100% actual code coverage on a complete set of high-level requirements, predictably and within verification schedule constraints. High-level requirements are similar to assertions and are compatible with assertion-based verification (ABV). However, the high-level requirements work at a higher level of abstraction, enabling greater design coverage and higher proof of correctness, independent of the software implementation. This formal approach ensures up to 100% actual coverage of the most important design aspects of the software as derived from the design specification. System-level verification by exemplary embodiments thus enables software engineers to efficiently produce high-quality software programs and protocols.

Exemplary embodiments obtain software code written in a programming language whose expressions embody the logic of the software code. Software code may be compiled in a computer or an embedded device to generate an abstract syntax tree (AST). Abstract syntax trees are generally not used for code verification because they may become very complex and require sophisticated compiler knowledge. Exemplary embodiments simplify the abstract syntax tree of the software code as generated by the compiler and then generate a logic representation of the software code. This logic representation is a behavior model of the software code which packages sections of the code into behavior model functions (BMF). Each BMF includes an input predicate, an action or actions, and an output predicate. Exemplary embodiments also derive well-defined formula sequences (WDF sequences) from the logic representation. A WDF sequence is a logic representation of a portion of the source code consisting of a dedicated initial variable, alternating sequences of event variables and actions, and a terminating variable. Exemplary embodiments then verify completeness and consistency of the software code by attempting to generate all possible well-defined formula sequences, i.e. a complete set of well-defined formula sequences (CS-WDFs). Successful generation of the CS-WDFs ensures verifiable compiled model behavior and complete code coverage.

Although the exemplary embodiments are described relative to software code written in the ANSI-C programming language, the present implementation is not limited to these embodiments and may be applied to software implemented in other programming languages, for example, C++, C#, Java and the like.

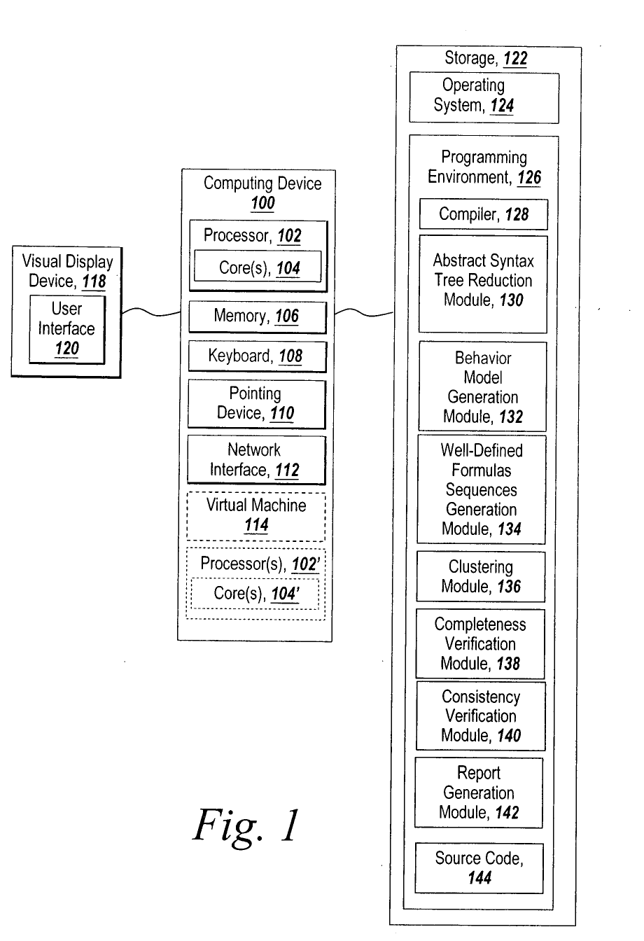

FIG. 1 depicts a computing device 100 suitable for practicing an exemplary embodiment of the present implementation. Computing device 100 may include memory 106, on which software according to one embodiment may be stored, processor 102, and optionally, one or more processor(s) 102′ for executing software stored in the memory 106, and other programs for controlling system hardware. Processor 102 and processor(s) 102′ may each be a single core or multiple core (104 and 104′) processor.

Memory 106 may include a computer system memory or random access memory such as dynamic random access memory (DRAM), static random access memory (SRAM), magneto-resistive random access memory (MRAM), extended data out random access memory (EDO RAM), flash memory, etc. A user may interact with the computing device 100 through a keyboard 108, a pointing device 110, and/or a visual display device 118 such as a computer monitor, which may include a user interface 120. Computing device 100 may include other I/O devices, for example a mouse, a motion based input device, and a camera, for receiving input from a user. The computing device 100 may further include a storage device 122, such as a hard-drive, CD-ROM, or other computer readable medium, for storing an operating system 124 and other related software, and for storing programming environment 126.

Programming environment 126 may be used to create, edit, verify and/or execute software. Programming environment 126 may include compiler 128 that compiles the software code and generates an abstract syntax tree. Programming environment 126 may also include an abstract syntax tree reduction module 130 that may be used to reduce or simplify the abstract syntax tree generated by compiler 128. Programming environment 126 may include behavior model generation module 132 that generates behavior model functions to represent the logic of the reduced abstract syntax tree, and well-defined formulas sequences generation module 134 that derives well-defined formula sequences from the behavior model. Programming environment 126 may further include clustering module 136 that hierarchically clusters the set of well-defined formulas sequences. Programming environment 126 may include completeness verification module 138 and consistency verification module 140 for verifying the set of well-defined formula sequences. Programming environment 126 may also include report generation module 142 which may report faults discovered in the verification process. Programming environment 126 may further include source code 144. Exemplary embodiments of the present implementation may be written in Java which is portable. All modules may be combined in any way or they may be distributed among different computing devices.

Additionally, the computing device 100 may include a network interface 112 to interface to a Local Area Network (LAN), Controller Area Network (CAN), Body Area Network (BAN), Wide Area Network (WAN) or the Internet through a variety of connections including, but not limited to, standard telephone lines, LAN or WAN links (e.g., IEEE 802.11, IEEE 802.16, T1, T3, 56 kb, X.25), broadband connections (e.g., Integrated Services Digital Network (ISDN), Frame Relay, asynchronous transfer mode (ATM)), wireless connections, or some combination of any or all of the above. The network interface 112 may include a built-in network adapter, network interface card, Personal Computer Memory Card International Association (PCMCIA) network card, Card Bus network adapter, wireless network adapter, Universal Serial Bus (USB) network adapter, modem or any other device suitable for interfacing the computing device 100 to any type of network capable of communication and performing the operations described herein. Moreover, the computing device 100 may be any computer system such as a workstation, desktop computer, server, laptop, handheld computer or other form of computing or telecommunications device that is capable of communication and that has sufficient processor power and memory capacity to perform the operations described herein.

The computing device 100 may be running substantially any operating system such as a version of the Microsoft® Windows® operating systems, Unix operating system, Linux operating systems, MacOS® operating system, etc. Implementations of computing device 100 may further operate an embedded operating system, a real-time operating system, an open source operating system, a proprietary operating system, an operating system for mobile computing devices, and/or another type of operating system capable of running on computing device 100 and performing the operations described herein.

Virtualization may be employed in computing device 100, for example, to dynamically share infrastructure and resources in the computing device may be shared dynamically. Virtualized processors may be used with programming environment 126 and other software in storage 122. A virtual machine 114 may be provided to handle a process running on multiple processors so that the process appears to be using only one computing resource rather than multiple. Multiple virtual machines may also be used with one processor.

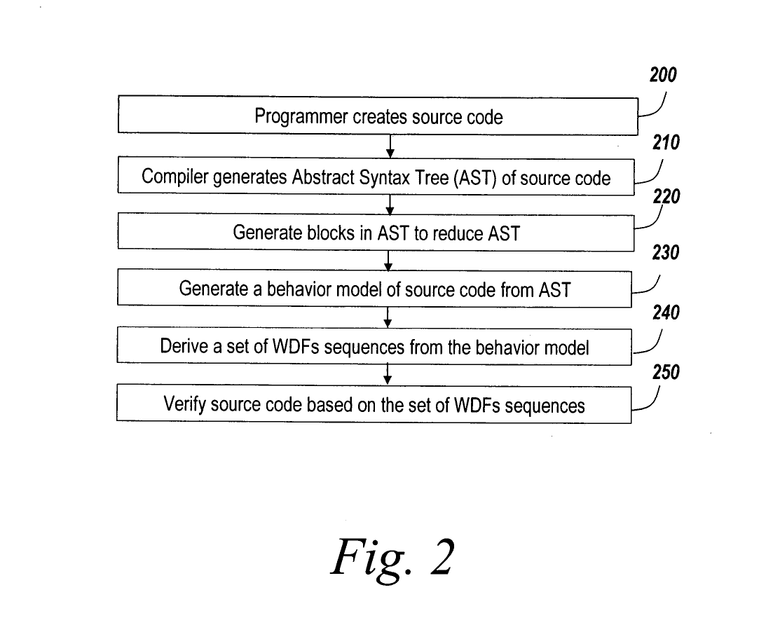

FIG. 2 illustrates a flowchart depicting steps performed by exemplary embodiments to verify software code. In step 200, in one embodiment, a software developer may create source code for a software program or protocol in programming environment 126 in accordance with pre-established requirements for the software program or protocol. In another embodiment, the software developer may create the source code in a different programming environment outside computing device 100. The software developer or any other user may compile the source code using compiler 128. In step 210, compiler 128 generates an abstract syntax tree (AST) of the source code. The user may then or before the start of compiling the source code invoke exemplary embodiments for automatic verification of the source code. In one embodiment, the user may use a user interface to select the source code and to run exemplary embodiments of the verification system. In another embodiment, the user may run exemplary embodiments of the verification system on the source code through a command-line interface.

In step 220, the abstract syntax tree reduction module 130 generates code blocks from the abstract syntax tree to reduce or simplify the abstract syntax tree. In step 230, the behavior model generation module 132 generates a logic representation of the source code in the form of behavior model functions from the reduced abstract syntax tree. In step 240, the well-defined formulas sequences generation module 134 generates a set of well-defined formulas sequences from the behavior model. In step 250, the completeness verification module 138 and consistency verification module 140 automatically verify the source code based on the set of well-defined formula sequences.

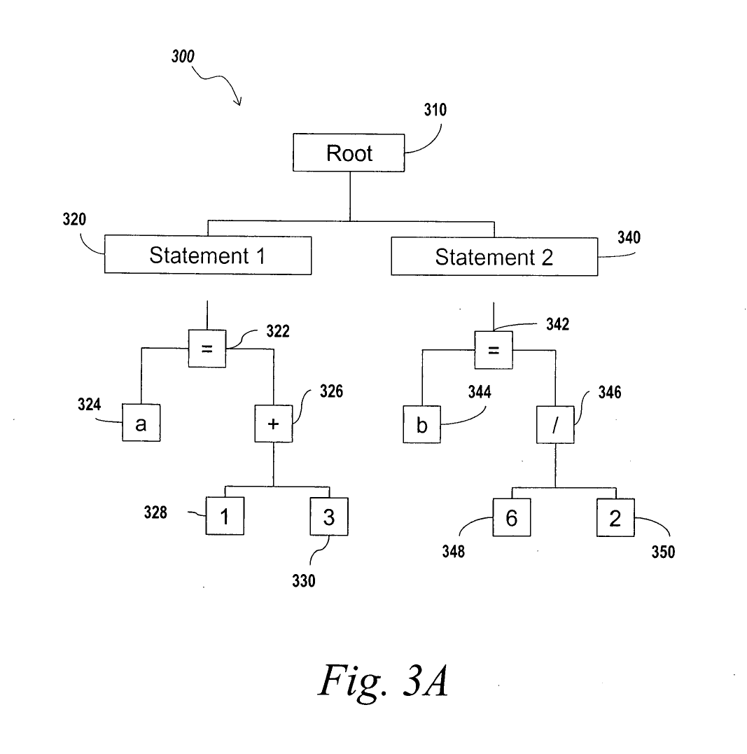

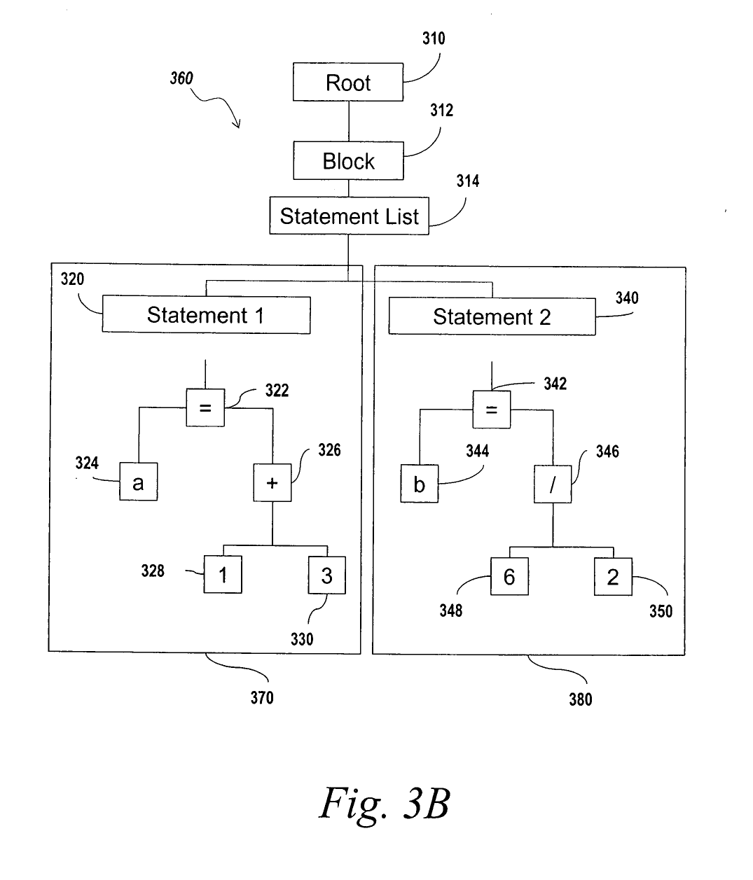

An abstract syntax tree (AST) is a finite, labeled, directed tree, in which the internal nodes represent operators and the leaf nodes represent the operands of the operators. Compiler 128 may compile the source code to generate an abstract syntax tree or a first intermediate representation of the source code. An exemplary embodiment of compiler 128 may be a GCC compiler. FIG. 3A illustrates exemplary abstract syntax tree 300 generated by compiler 128. Abstract syntax tree 300 consists of root node 310 and two branches for statements 320 and 340. The first branch includes an internal node 326 representing an add operator, a leaf node 328 representing operand “1” for the add operator and a leaf node 330 representing operand “3” for the add operator. The first branch also includes an internal node 322 representing the variable assignment operator and leaf node 324 representing variable “a.” The first branch, as a whole, represents the assignment of “1+3” to the variable “a.” Similarly, the second branch includes internal node 346 representing the divide operator, leaf node 348 representing operand “6” and leaf node 350 representing operand “2” for the divide operator. The second branch also includes internal node 342 representing the variable assignment operator and leaf node 344 representing variable “b.” The second branch, as a whole, represents the assignment of “6/2” to the variable “b.”

An abstract syntax tree for a medium or large software program may become too large and complex to verify without simplification. So, exemplary embodiments employ the abstract syntax tree reduction module 130 to reduce or simplify the abstract syntax tree 300 into a reduced abstract syntax tree 360, as illustrated in FIG. 3B. The abstract syntax tree reduction module 130 may walk over abstract syntax tree 300, identify sets of instructions without branches and convert them into code blocks. In one embodiment, a code block includes lines of code written as part of a statement. As an example, reduced abstract syntax tree 360 includes a root node 310, a block 312 which encapsulates all subsequent branches, a statement list node 314, a block 370 representing the left branch and a block 380 representing the right branch of the abstract syntax tree 300. Exemplary embodiments may operate on compiled representations of the source code other than an abstract syntax tree to perform similar reduction/simplification. Abstract syntax tree reduction module 130 may also take reduced abstract syntax tree 360 as input and generate original abstract syntax tree 300. The technique of reducing or simplifying an abstract syntax tree in exemplary embodiments is thus reversible.

Behavior model generation module 132, which includes a compiler, generates a behavior model, i.e. a logic representation or a second intermediate representation of the source code. The behavior model may be a collection of behavioral model functions, each representing a section of the logic of the source code. A behavior model is a logic representation of the source code and can be understood and analyzed by non-programmers. A logic representation of source code is a transformed version of the source code from the code domain to a logic domain, which can be displayed textually or visually. This transformed version of the source code is more conducive to debugging and makes the code verification process faster and easier. A behavior model may include a set of behavior model functions, each embodying the logic of a portion of the source code. In an exemplary embodiment, behavior model generation module 132 may be a macro that converts an abstract syntax tree or a reduced abstract syntax tree into a set of behavior model functions, which represents the semantics expressed in the source code. Behavior model generation module 132 includes a compiler which parses the set of behavior model functions to verify that the conversion from the source code to the behavior model is accurate.

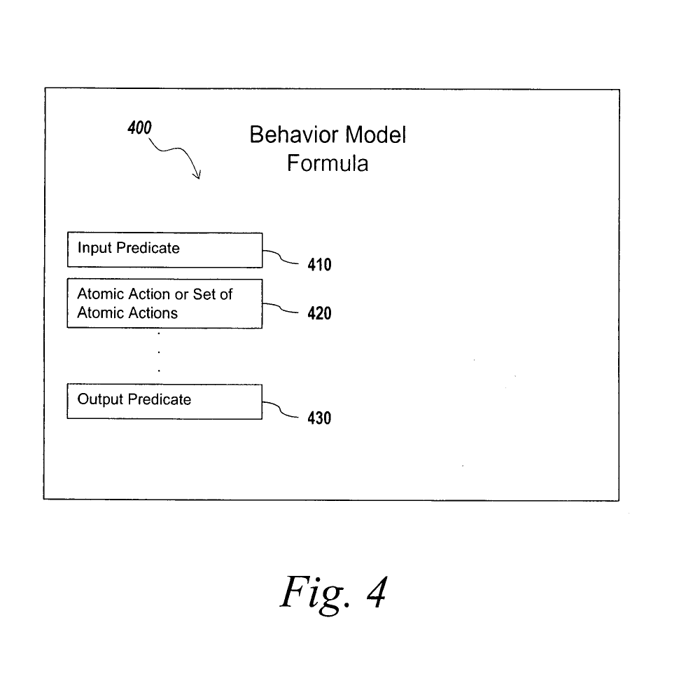

FIG. 4 illustrates exemplary behavior model function 400 generated by behavior model generation module 132. Behavior model function 400 may begin by identifying an input predicate 410 from the abstract syntax tree which is a pre-condition that establishes the condition for activating an atomic action or a set of atomic actions. An exemplary embodiment of input predicate 410 may be a Boolean function of an event variable. An event variable is associated with an event that may be an internal or external action. An external event variable may be used to simulate interactions with concurrent processes, e.g. received messages. An event variable may be a state, branching or terminating variable. A state variable, when set to true, automatically sets all other event variables to false. Therefore, at any point in execution, only one state variable is true and all other state variables are false. Branching variables are used to describe non-deterministic behavior within a state.

Behavior model function 400 may include an atomic action or a set of atomic actions 420. An atomic action is an action that effectively happens all at once. In one embodiment, behavior model formula 400 may include a single atomic action which is initiated when the input predicate becomes true. In another embodiment, behavior model formula 400 may include a set of atomic actions which are initiated when the input predicate becomes true and which are executed in the order as they are listed. Behavior model formula 400 may also end with output predicate 430 which is a set of possible events that may take place on action termination. Output predicate 430 may define a set of event variables, among which only one will become true upon the termination of atomic action or set of atomic actions 420. Behavior model generation module 132 may also take a set of behavior model finctions as input and mirror it on the original source code. The technique of generating a behavior model in exemplary embodiments is thus reversible.

Well-defined formulas sequences generation module 134 may then generate well-defined formulas sequences, which are sections in the behavior model, as a depth-first search tree. A well-defined formulas sequence is a sequence of behavior model sections which follow logically in the behavior model. A set of well-defined formulas sequences provides complex entities for reasoning and analyzing completeness and consistency of the source code.

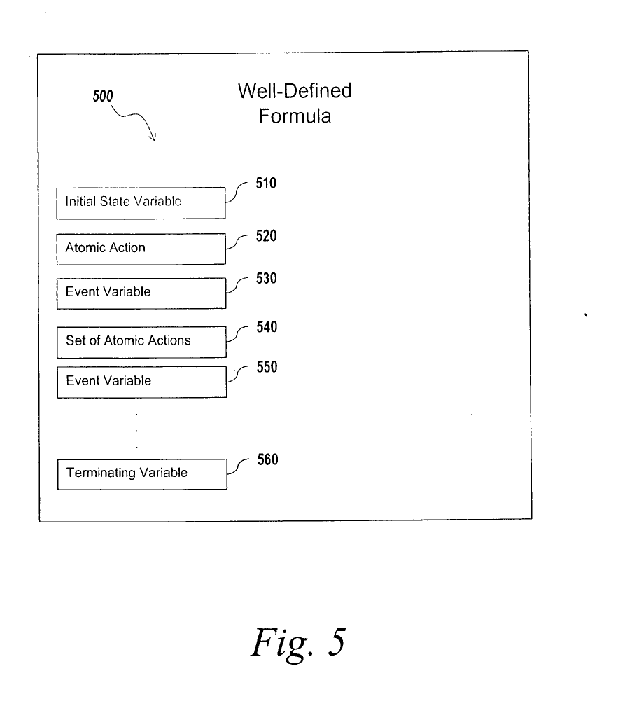

FIG. 5 illustrates exemplary well-defined formula (WDF) 500. Well-defined formula 500 may begin with a dedicated state event variable 510. Well-defined formula 500 may include a sequence of alternating sets of event variables and atomic actions (or sets of atomic actions) which logically follow in time. For example, atomic action 520 is logically followed by an event variable 530. The event variable 530 is logically followed by set of atomic actions 540, which is, in turn, logically followed by event variable 550. Event variables in well-defined formula 500 may be Boolean expressions of state or branching variables that express a pre-condition for activating the following atomic action or set of atomic actions. For example, the event variable 530 may express the pre-condition for activating the set of atomic actions 540. Well-defined formula 500 may end with terminating state variable 560 which becomes true upon the termination of the actions in well-defined formula 500. Well-defined formula sequence generation module 134 may also take a set of well-defined formula sequences as input and generate a behavior model. The technique of generating a set of well-defined formula sequences from a behavior model in exemplary embodiments is thus reversible. Exemplary embodiments may also mirror a set of well-defined formula sequences on the source code.

All possible sequences of WDFs are automatically generated from the behavior model and form a Depth-First Search Tree (DFST) defined by the logic. Successful creation of the complete set of all possible sequences of WDFs (CS-WDFs) guarantees completeness and consistency of the model behavior. This verifies that nothing is omitted and there is no unwanted behavior in the source code. The CS-WDFs presents the “program-life sequences set.”

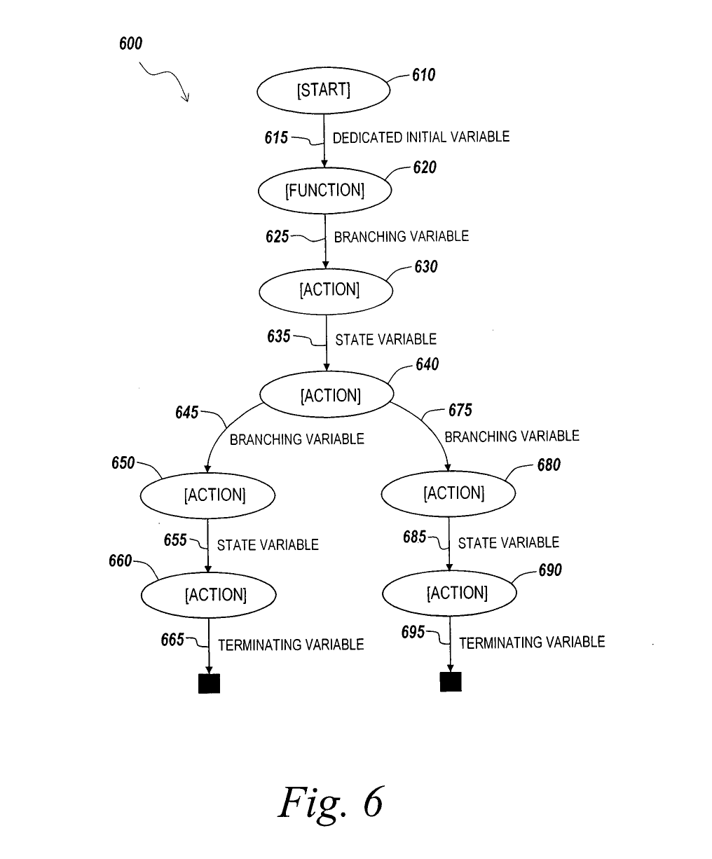

FIG. 6 illustrates an exemplary well-defined formula sequence 600. The sequence 600 starts with a dedicated initial variable 615 which activates a function 620. A branching variable 625 activates an action 630. Alternating variables (e.g. 635, 645, 655, 675, 685) and actions (e.g. 640, 650, 660, 680, 690) follow logically in the WDF sequence. Each branch of the WDFs sequences ends with a terminating variable (the left branch ending at terminating variable 665, and the right branch ending at terminating variable 695).

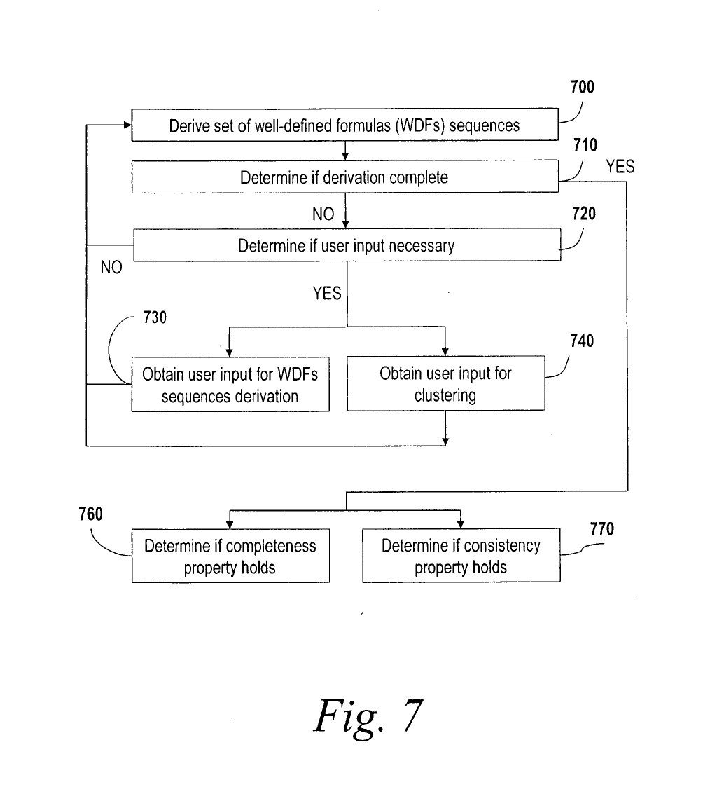

FIG. 7 illustrates a flowchart depicting steps performed by exemplary embodiments to derive a complete set of well-defined formulas (WDFs) sequences. In step 700, well-defined formulas sequences generation module 134 may generate all possible WDFs sequences from the behavior model. In step 710, well-defined formulas sequences generation module 134 may determine if WDFs sequences generation is complete. If all possible WDFs sequences have not been generated, exemplary embodiments determine if user input is necessary in step 720 and, if so, prompts user input in one of two ways through user interface 120. First, well-defined formulas sequences generation module 134 may require the user's input to continue generating WDFs sequences. User interface 120 may prompt the user to enter instructions or information on WDFs sequences generation in step 730. If an entry is made, then well-defined formulas sequences generation module 134 may continue to derive additional WDFs in step 700. Second, the behavior model of the source code may be too complex for fast generation of WDFs and well-defined formula sequence generation module 134 may be timing out as a result. User interface 120 may prompt the user to initiate clustering to simplify the set of WDFs being generated in step 740. Upon user instruction for clustering, clustering module 136 may create clusters in the WDFs.

Hierarchical decomposition or clustering of the well-defined formula sequences is implemented within the proposed framework for handling complexity problems and avoiding a state explosion problem. The state explosion problem refers to the unmanageable size of state spaces even for reasonably sized programs. Exemplary embodiments may use a clustering method applied to the set of WDF sequences, i.e. WDFs, to decompose them hierarchically into a set of clusters. Clusters are created for a set of well-defined formula sequences of sections starting at a specific single state variable (cluster entry point). All state variables included in a cluster are reachable via chains starting from the cluster entry point. All well-defined formula sequences of sections within the cluster end with a terminating variable. The aforementioned properties define transition similarity within the well-defined formula sequences of sections in the behavioral model for efficient decomposition. In this way, the clusters are formed by using bottom up approach and may be created on the basis of finctions calls. The efficiency of the decomposition is determined as a ratio of the number of all state transitions in the original set of chains (WDF) and the number of the transitions between the created clusters.

Each cluster may be verified independently. The initial state variable (dedicated variable) of each cluster is activated by the well-defined formula sequences of the sections in the cluster, starting form the root of the complete set of well-defined formula sequences (CS-WDFs). All external variables, including variables from other modules, are synchronized with the internal behavior of the cluster. These external variables are provided when the cluster is in a state that requires the external variables. If the CS-WDFs are successfully generated for the cluster, then the cluster is marked as a “black box” which contains WDF sequences inside. The procedure for forming clusters is applied recursively to the hierarchy of WDFs until the clusters have sufficiently low complexity and can be verified in an acceptable time.

The complexity of the clusters is reduced at each step of clustering. The verified black boxes can become reusable components in the program, thus reducing time and effort spent in writing code with the WDFs included in the black boxes. Exemplary embodiments may use the clusters in a “black box” verification approach which verifies each cluster independently and allows the verification process to be scalable to large and complex software code. In one embodiment, clustering may be performed only upon user prompting. In another embodiment, clustering may be performed automatically. Well-defined formula clustering module 136 may also take a cluster as input and mirror them on the original source code.

When the derivation of all well-defined formula sequences is complete, exemplary embodiments perform code verification by verifying completeness and consistency. In step 760, completeness verification module 138 may analyze the set of WDFs or the set of clusters to determine if all possible WDFs, i.e. the complete set of well-defined formula sequences (CS-WDFs), have been generated. Successful generation of the CS-WDFs proves verification of the completeness of the model behavior of the software code. Based on the successful completion of the CS-WDFs, the following key features of the behavioral model of the source code are verified automatically. All branching event variables in the behavior model are activated at least once during the generation of the CS-WDFs. All well-defined formula sequences in the CS-WDFs, starting from the initial event state variable, are terminating, i.e., reaching a terminating state variable. All external event variables are synchronized with the internal behavior of the behavioral model, i.e., with corresponding state variables. External event variables are available when the behavioral model requires them during the execution of the source code. All states of the embedded state transition graph in the behavior model (i.e. in the set of behavior model functions) are visited. Accordingly, all state variables in the behavior model are reachable and, therefore, the source code does not have an associated graph reachability problem. There are no infinite loops in the behavior model, wherein an infinite loop is a sequence of sections with the tail of the sequence connected to its head. Also, there are no unactivated sequences in the behavior model and, correspondingly, in the source code. However, if the completeness property fails because of a fault, this is reported to the user, as will be discussed below.

In addition, in step 770, consistency verification module 140 may detect faults that result in lack of consistency. For example, several sections from different behavior model functions may be activated simultaneously during the process of building the CS-WDFs and their constituent actions may be contradicting. A breaking/conflicting point is then reached. The fault is reported to the user, as will be discussed below. More specifically, the sequence of chains initiated at the start of the creation of CS-WDFs and leading to this breaking/conflicting point may be identified and provided to the user. Accordingly, the conflicting actions may be disallowed or deactivated and the anticipated WDF sequences rooted at the conflict detection point will not be created.

A prohibited state variable, activated after completion of a given action, expresses a state which the model behavior or program is not allowed to reach. Accordingly, anticipated WDF sequences rooted at the prohibited state variable will not be created. These prohibited state variables will be identified and the well-defined formula sequences initiated at the start of the creation of the CS-WDFs and leading to this breaking point of the model behavior will be recognized and displayed to the user. Therefore, the graph reachability problem cannot be solved in this scenario and the CS-WDFs cannot be created. This fault may also be reported to the user.

If a conflict detection point has not been recognized and a prohibited state variable has not been reached during creation of the CS-WDFs, then consistency verification module 140 verifies that the source code is consistent. Exemplary embodiments are not restricted to the faults addressed above.

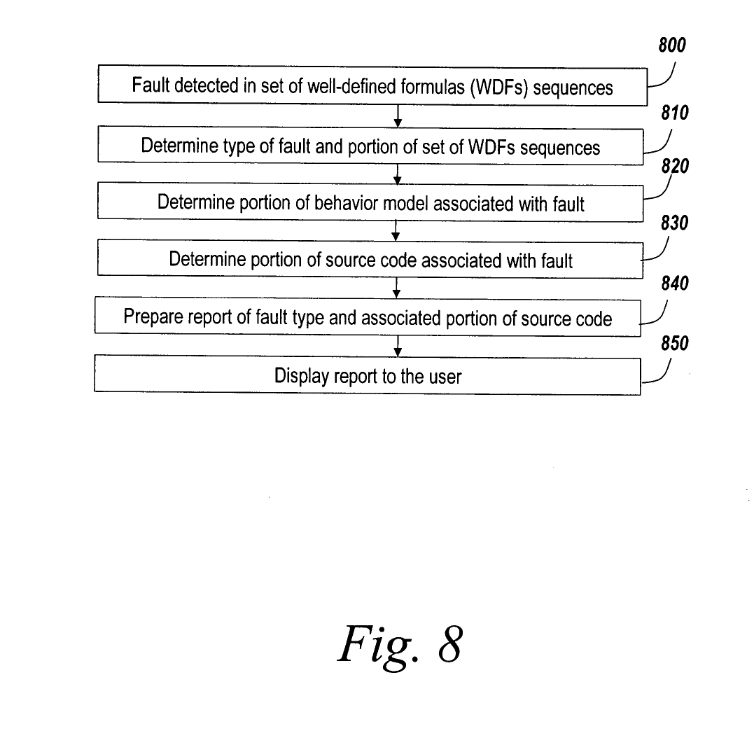

Faults and timeouts may give rise to issues in completeness and consistency, as discussed above. Each time a fault or a timeout is detected, the necessary diagnostic information is provided to the user for debugging the program. The diagnostic information can be used by the user to eliminate the faults in the source code based on the reverse transformation approach. FIG. 8 illustrates a flowchart depicting steps performed by exemplary embodiments to report faults in the source code to the user.

In step 800, completeness verification module 138 or consistency verification module 140 detects a fault during generation of the set of well-defined formula sequences. In step 810, exemplary embodiments determine the type of fault. Well-defined formulas sequences generation module 134 and behavior model generation module 132 can mirror a portion in the WDF sequences and behavior model, respectively, to the original source code. Thus, starting from the portion of WDFs that a fault originates in, exemplary embodiments determine the associated portion of the source code, as illustrated in steps 820 and 830. In step 840, report generation module 142 may generate a report documenting the type of fault (e.g. unreachable code) and the portion of the source code that is the origin of the fault. In step 850, this report may be presented to the user on user interface 120 to provide diagnostic information during the verification process. The user may then switch to a code editor, correct the problem with the help of the diagnostic information, and re-run the verification process. This iterative process of verification, feedback and fault correction over the entire source code until the complete set of well-defined formula sequences (CS-WDFs) is generated ensures complete code coverage and verifiable compiled model behavior in exemplary embodiments.

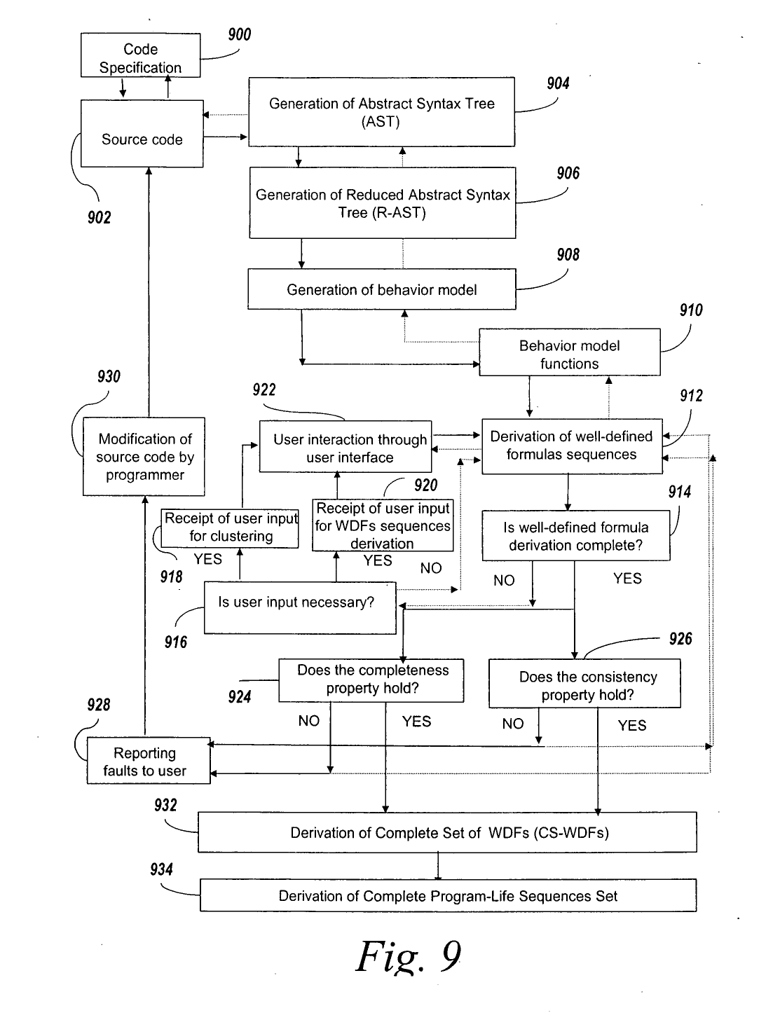

FIG. 9 illustrates a flowchart summarizing steps performed by exemplary embodiments to verify source code and correct faults in the source code. Using code specification 900 describing requirements for software code, a software programmer creates source code 902. In step 904, the compiler 128 generates an abstract syntax tree of the source code from the source code 902. In step 906, the abstract syntax tree reduction module 130 generates a reduced abstract syntax tree from the abstract syntax tree. In step 908, the behavior model generation module 132 generates a behavior model consisting of behavior model functions 910 from the reduced abstract syntax tree. In step 912, the well-defined formulas sequences generation module 134 generates a set of well-defined formulas sequences from the behavior model functions 910.

In step 914, exemplary embodiments then determine if generation of the set of well-defined formula sequences is complete. If the result is negative, in step 916, exemplary embodiments determine if user input is necessary to continue generation of well-defined formulas sequences. If the result is negative, then exemplary embodiments return to step 912 to generate further well-defined formulas sequences. However, if user input is necessary for continued well-defined formula generation, the user may initiate cluster formation in step 918, in which the clustering module 136 generates clusters in the well-defined formula sequences. If user input is necessary, the user may also provide some other input in step 920 that allows continued well-defined formula generation. These user interactions occur through a user interface in step 922.

If the generation of well-defined formula sequences is complete, then the completeness property is checked by the completeness verification module 138 in step 924 and the consistency property is checked by the consistency verification module 140 in step 926. If both properties hold, then the complete set of well-defined formula sequences (CS-WDFs) is generated in step 932. Finally, the complete program-life sequences set is generated in step 934.

However, if either the completeness or the consistency property does not hold, the report generation module 142 generates a report on the type of fault in step 928. Additionally, exemplary embodiments trace the portion of the well-defined formula associated with the fault back to the corresponding portion of the source code, as shown by the dotted arrows. In step 930, using information on the type of fault and the portion of the source code that originates the fault, the programmer can modify and debug the source code. Exemplary embodiments fully verify the source code through the above iterative process of fault detecting and debugging.

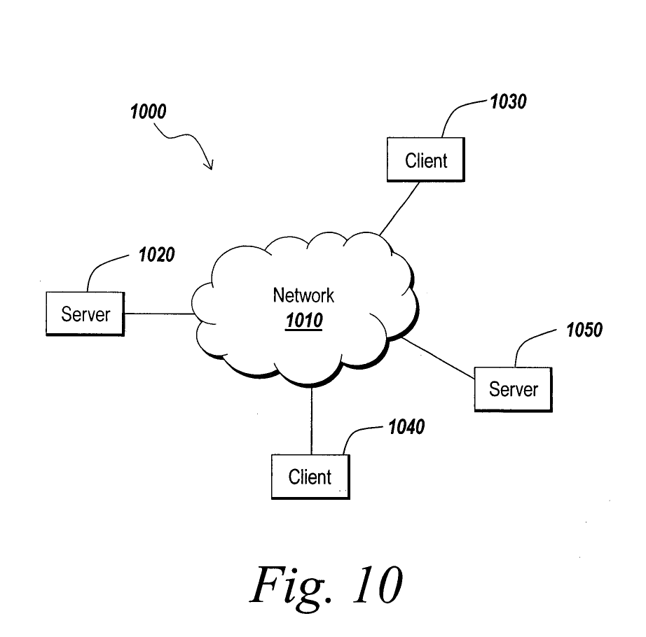

FIG. 10 is an exemplary network environment 1000 (hereinafter environment 1000) suitable for processing distributed implementations of the exemplary embodiments. Environment 1000 may include one or more servers 1020/1050 coupled to clients 1030/1040 via a communication network 1010. In one implementation, servers 1020/1050 and/or clients 1030/1040 may be implemented via the computing device 100. The network interface 112 of the computing device 100 may enable the servers 1020/1050 to communicate with the clients 1030/1040 through the communication network 1010.

The communication network 1010 may include Internet, intranet, Local Area Network (LAN), Wide Area Network (WAN), Metropolitan Area Network (MAN), wireless network (e.g., using IEEE 802.11, Bluetooth, etc.), etc. The communication network 1010 may use middleware, such as Common Object Request Broker Architecture (CORBA) or Distributed Component Object Model (DCOM) to allow a computer (e.g., client 1020) on the communication network 1010 to communicate directly with another computer or device (e.g., client 1030) that is connected to the communication network 1010. In addition, the communication network 1010 may use Remote Method Invocation (RMI) or Remote Procedure Call (RPC) technology. RMI and RPC are exemplary technologies that allow functions, methods, procedures, etc., to be called over the environment 1000. For example, the client 1030 may invoke a method that resides remotely on the client 1040. Additionally, the servers 1020/1050 may provide the clients 1030/1040 with software components or products under a particular condition, such as a license agreement.

The source code files in programming environment 126 may include software code written in a programming language, such as C, which may further be in a format and style following the ANSI/ISO C standard. Additionally, the source code files may be in a programming language other than C. The software code in the source code files may be generated to run on any operating system, such as a real-time operation system, or for a specific processor.

The foregoing description of exemplary embodiments provides illustration and description, but is not intended to be exhaustive or to limit the implementation to the precise form disclosed. Modifications and variations are possible in light of the above teachings or may be acquired from practice of the implementation. The automatic software verification tool in exemplary embodiments may be available to an external developer through an Application Programming Interface (API).

Code for exemplary embodiments may be provided as one or more computer-readable programs embodied on or in one or more mediums operating alone or in combination. The mediums may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, JAVA.

Since certain changes may be made without departing from the scope of the present implementation, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present implementation and that the illustrations contained herein are singular examples of a multitude of possible depictions of the present implementation.

The scope of the implementation is defined by the claims and their equivalents.

We claim:

1. A computer-implemented method of verifying software code, said method comprising the steps of:
generating a first intermediate representation of the software code;
generating a second intermediate representation of the software code from the first intermediate representation;
deriving a set of well-defined formula sequences from the second intermediate representation of the software code; and
verifying the software code based on the set of well-defined formula sequences.

2. The method of claim 1, wherein the second intermediate representation of the software code comprises a plurality of units, each unit including:
an input predicate that establishes a first condition for activating an action;
the action; and
an output predicate that defines a second condition that can be specified after the termination of the action.

3. The method of claim 1, wherein the first intermediate representation of the software code is an abstract syntax tree (AST) of the software code generated by a compiler.

4. The method of claim 1, further comprising mirroring the second intermediate representation of the software code on a portion of the software code.

5. The method of claim 1, further comprising mirroring the set of well-defined formula sequences on a portion of the software code.

6. The method of claim 1, wherein a well-defined formula sequence comprises a plurality of units activated in sequence, each unit including:
a dedicated variable specifying an initial condition;
a sequence of alternating sets of variables and actions; and
a terminating variable that is activated after the termination of the sequence of alternative sets of variables and actions.

7. The method of claim 1, further comprising the step of generating a complete set of well-defined formula sequences.

8. The method of claim 7, further comprising the step of determining if a complete set of well-defined formula sequences is successfully generated.

9. The method of claim 8, further comprising the step of verifying completeness of the second intermediate representation based on the successful generation of the complete set of well-defined formula sequences.

10. The method of claim 9, wherein the step of verifying completeness indicates if all branching variables in the second intermediate representation of the software code are activated at least once during the generation of the complete set of well-defined formula sequences.

11. The method of claim 9, wherein the step of verifying completeness indicates if all well-defined formula sequences in the complete set of well-defined formula sequences are terminating.

12. The method of claim 9, wherein the step of verifying completeness indicates if all external event variables are synchronized with the second intermediate representation of the software code.

13. The method of claim 9, wherein the step of verifying completeness indicates if infinite loops are absent in the second intermediate representation of the software code.

14. The method of claim 9, wherein the step of verifying completeness indicates if code coverage is complete.

15. The method of claim 9, wherein the step of verifying completeness indicates if unactivated sequences are absent in the software code.

16. The method of claim 8, further comprising the step of detecting faults, timeouts, or both, in the software code based on an unsuccessful generation of the complete set of well-defined formula sequences.

17. The method of claim 1, further comprising the step of verifying consistency of the second intermediate representation of the software code based on detecting a conflict or an unreachable portion in the second intermediate representation of the software code.

18. The method of claim 1, further comprising the steps of:
hierarchically decomposing the set of well-defined formula sequences into clusters of well-defined formula sequences; and
independently verifying each cluster of well-defined formula sequences.

19. A system in a computer for verifying software code, said system comprising:
a first intermediate representation generation facility that generates a first intermediate representation of the software code;
a second intermediate representation generation facility that generates a second intermediate representation of the software code from the first intermediate representation;
a well-defined formula sequence generation facility that derives a set of well-defined formula sequences from the second intermediate representation of the software code; and
a code verification facility that verifies the software code based on the set of well-defined formula sequences.

20. The system of claim i 9, wherein the second intermediate representation of the software code comprises a plurality of units, each unit including:
an input predicate that establishes a first condition for activating an action;
the action; and
an output predicate that defines a second condition that can be specified after the termination of the action.

21. The system of claim 19, further comprising a compiler which generates the first intermediate representation of the software code and wherein the first intermediate representation is an abstract syntax tree (AST).

22. The system of claim 19, wherein a compiler generates a logic abstract syntax tree (L-AST) of the software code from the second intermediate representation of the software code.

23. The system of claim 19, wherein the well-defined formula sequence generation facility generates the second intermediate representation of the software code from the set of well-defined formula sequences.

24. The system of claim 19, wherein a well-defined formula sequence comprises a plurality of units activated in sequence, each unit including:
a dedicated variable specifying an initial condition;
a sequence of alternating sets of variables and actions; and
a terminating variable that is activated after the termination of the sequence of alternative sets of variables and actions.

25. The system of claim 19, further comprising a code completeness verification facility for verifying completeness of the second intermediate representation of the software code based on the successful generation of a complete set of well-defined formula sequences.

26. The system of claim 25, wherein the code completeness verification facility detects faults, timeouts, or both, in the software code based on an unsuccessful generation of the complete set of well-defined formula sequences.

27. The system of claim 19, further comprising a code consistency verification facility for verifying consistency of the second intermediate representation of the software code based on detection of a conflict or an unreachable portion in the second intermediate representation of the software code.

28. The system of claim 19, further comprising a well-defined formula sequence clustering facility for:
hierarchically decomposing the set of well-defined formula sequences into clusters of well-defined formula sequences; and
independently verifying each cluster of well-defined formula sequences.

29. A computer-readable medium containing computer-executable instructions for verifying software code, said instructions comprising:
instructions for generating a first intermediate representation of the software code;
instructions for generating a second intermediate representation of the software code from the first intermediate representation;
instructions for deriving a set of well-defined formula sequences from the second intermediate representation of the software code; and
instructions for verifying the software code based on the set of well-defined formula sequences.

30. The medium of claim 29, wherein the second intermediate representation of the software code comprises a plurality of units, each unit including:
an input predicate that establishes a first condition for activating an action;
the action; and
an output predicate that defines a second condition that can be specified after the termination of the action.

31. The medium of claim 29, wherein the first intermediate representation of the software code is an abstract syntax tree (AST) of the software code generated by a compiler.

32. The medium of claim 29, further comprising instructions for mirroring the second intermediate representation of the software code on a portion of the software code.

33. The medium of claim 29, further comprising instructions for mirroring the set of well-defined formula sequences on a portion of the software code.

34. The medium of claim 29, wherein a well-defined formula sequence comprises a plurality of units activated in sequence, each unit including:
a dedicated variable-specifying an initial condition;
a sequence of alternating sets of variables and actions; and
a terminating variable that is activated after the termination of the sequence of alternative sets of variables and actions.

35. The medium of claim 29, further comprising instructions for generating a complete set of well-defined formula sequences.

36. The medium of claim 35, further comprising instructions for determining if a complete set of well-defined formula sequences is successfully generated.

37. The medium of claim 36, further comprising instructions for verifying completeness of the second intermediate representation of the software code based on the successful generation of the complete set of well-defined formula sequences.

38. The medium of claim 37, wherein the instructions for verifying completeness indicate if all branching variables in the second intermediate representation of the software code are activated at least once during the generation of the complete set of well-defined formula sequences.

39. The medium of claim 37, wherein the instructions for verifying completeness indicates if all well-defined formula sequences in the complete set of well-defined formula sequences are terminating.

40. The medium of claim 37, wherein the instructions for verifying completeness indicates if all external event variables are synchronized with the second intermediate representation of the software code.

41. The medium of claim 37, wherein the instructions for verifying completeness indicates if infinite loops are absent in the second intermediate representation of the software code.

42. The medium of claim 37, wherein the instructions for verifying completeness indicates if code coverage is complete.

43. The medium of claim 37, wherein the instructions for verifying completeness indicates if unactivated sequences are absent in the software code.

44. The medium of claim 36, further comprising instructions for detecting faults, timeouts, or both, in the software code based on an unsuccessful generation of the complete set of well-defined formula sequences.

45. The medium of claim 29, further comprising instructions for verifying consistency of the second intermediate representation of the software code based on detecting a conflict or an unreachable portion in the second intermediate representation of the software code.

46. The medium of 29, further comprising:
instructions for hierarchically decomposing the set of well-defined formula sequences into clusters of well-defined formula sequences; and
instructions for independently verifying each cluster of well-defined formula sequences.
